(19) United States
(12) Patent Application Publication
(10) Pub. No.: US 2019/0308592 A1
(43) Pub. Date: Oct. 10, 2019

(54) MOBILE LARGE MANIPULATOR

(71) Applicant: Schwing GmbH, Herne (DE)

(72) Inventors: Christoph Sacken, Essen (DE); Mykola Oleksyuk, Hattingen (DE); Jörg-Peter Karrie, Gelsenkirchen (DE); Wolfgang Tebeek, Marl (DE); Carsten Conrad, Recklinghausen (DE); Johannes Henikl, Dorsten (DE); Björn Gläsert, Witten (DE)

(21) Appl. No.: 16/469,580

(22) PCT Filed: Dec. 21, 2017
(86) PCT No.: PCT/EP2017/084067

§ 371 Date: Jun. 13, 2019

(30) Foreign Application Priority Data
Dec. 22, 2016 (DE) 10 2016 125 450.9

(51) Int. Cl. B60S 9/02; B66C 23/78; B60K 35/00; G01M 1/12

(52) U.S. Cl. CPC B60S 9/02; B66C 23/78; E04G 21/0445; G01M 1/122; B60K 2370/16; B60K 35/00

(57) ABSTRACT

A mobile large manipulator includes a chassis, unfoldable and/or extendable working boom, supporting struts, vertically extendable supporting legs, and a micro-controller-based program-controlled supporting aid. The unfoldable and/or extendable working boom is arranged rotatably around a vertical axis on the chassis. The supporting struts are respectively arranged on the chassis and are horizontally extendable from a travel position to a supporting position. The vertically extendable supporting legs are arranged on respective outer ends of the supporting struts. The supporting legs support the mobile large manipulator via respective supporting forces of the supporting legs. The supporting aid is configured to determine supporting forces for the respective supporting legs based, at least in part, on the supporting position of the supporting struts in which the chassis of the large manipulator is deployed unstressed in a support state.

The invention relates to a mobile large manipulator, which can be supported for the working operation, as well as a method for the program-controlled assistance for the supporting of a mobile large manipulator.

Mobile large manipulators are known from the prior art, for example from WO 2005/095256 A1. They include in particular a chassis, a working boom, unfoldable and/or extendable, arranged rotatably around a vertical axis on the chassis, supporting struts, which are respectively arranged on the chassis, and are horizontally totally or partially extendable, from a travel position, into a supporting position, as well as supporting legs, vertically extendable with drive units, arranged on the outer ends of the supporting struts, with which legs the mobile large manipulator can be supported with the formation of a respective supporting force of the supporting legs.

In the supporting process of a large manipulator with four pivotable or extendable or telescopable supporting struts, tensioning of the chassis can occur, in particular if, to level the chassis, the height of individual supporting legs of the support struts is re-adjusted at the end of the supporting process. Here, unnecessarily high supporting forces can come up, already before the start-up of the large manipulator, in individual supporting legs, while the supporting forces are too low on other supporting legs.

In the following, the term “chassis” means the combination of the chassis of the truck, on which the large manipulator is constructed, as well as the basic frame, on which the working boom is mounted, and which contains further components of the large manipulator.

A non-uniform distribution of the support load in the supporting of a large manipulator is, at a rule, not recognizable for the operator, in particular in a rigidly-constructed basic frame, as only a inclinometer (bubble tube) is, as a rule, provided for the levelling of the large manipulator, and as soon as all supporting legs stand, purely optically, firmly on the ground, and the large manipulator is levelled, the set-up process is concluded, without a stress of the chassis being recognizable for the user.

After the start-up of the large manipulator, this unbalanced supporting load distribution leads to individual supporting legs or the support struts being loaded more strongly than necessary or even being overloaded.

WO 2005/096256 A1 proposes a coupled actuation of the drive units of the four supporting legs with the help of a hand-operated control member, for the automatic supporting process of a large manipulator, in the form of a truck-mounted concrete pump, in order to avoid a tensioning of the basic frame in the supporting process through a non-uniform supporting force distribution.

In the document EP 272876, a monitoring unit is suggested for the supporting loads of the supporting legs of a mobile crane, in which, at the conclusion of the supporting process, the sum of all support loads should correspond to the total weight of the mobile crane. Furthermore, it is suggested to determine the supporting loads, and to compensate for them against one another. A corresponding supporting force sensor system is provided, on the supporting legs, for the compensation of the supporting forces.

In confined construction site conditions, often only a special support configuration, for example a partial support, is possible, i.e. while the supporting legs are all extended down to the ground, one or multiple supporting struts, however, are not completely pivoted or extended or telescoped from the basic frame, in order to, for example at a construction site next to a street, still leave enough room free for the through traffic. It has turned out that, in such type of partial supports, the methods suggested in the above-mentioned documents do not lead to the desired results.

It is therefore the object of the present invention to provide a mobile large manipulator, with which, in the supporting process, the supporting load of the supporting legs can optimally be adapted to the respective support configuration. Further, it is the object of the present invention to specify a method with which the supporting load of the supporting legs, in the supporting process, can be optimally set for different supporting processes.

This object is achieved through a mobile large manipulator according to claim 1. Further, this object is achieved through a method for supporting a mobile large manipulator according to claim 13.

Further developments of the invention are specified in the dependent claims. It is to be pointed out that the features individually listed in the claims can also be combined with one another in any technologically useful way, and thusly show further configurations of the invention.

A mobile large manipulator according to the invention comprises a chassis, an unfoldable and/or extendable working boom rotatably arranged around a vertical axis on the chassis, supporting struts, which are respectively arranged on the chassis and, from a travel position, are horizontally extendable, entirely or partially, into a supporting position, as well as vertically extendable supporting legs arranged on the outer ends of the support struts, which legs brace the large manipulator with the formation of a supporting force. The invention distinguishes itself in particular through a program-controlled supporting aid, which is set up to determine target supporting forces for the individual supporting legs, taking into account the supporting position of the support struts, by which struts the chassis of the large manipulator, in the supported state, is set up in an unstressed manner.

The invention is based on the recognition that optimal supporting forces, acting upon the individual supporting legs are strongly dependent upon the supporting position of the supporting struts, that is, how far support struts are extended or folded down from the chassis. In only lightly or not extended/folded down supporting struts, the supporting forces of the supporting legs should, as a rule, be significantly higher, in order to avoid a tensioning of the chassis at the end of the set-up process, whereby, even in extended supporting struts, the supporting forces are optimally distributed onto the supporting legs.

In a preferred embodiment of the invention, the program-controlled supporting aid is configured to take the center of gravity of the large manipulator into account for the determining of the supporting forces. Through the taking into account of the center of gravity of the large manipulator, the program-controlled supporting aid can particularly exactly determine the optimal supporting forces for the individual supporting legs.

The center of gravity can be firmly pre-specified, the supporting aid is, however, advantageously set up to calculate the position of the center of gravity because, for example, different supporting positions of the support struts or different loadings of the large manipulator displace the center of gravity. In taking into account the actual center of gravity, the target supporting forces can be even more precisely determined.

Advantageously, the supporting aid is set up to take fill levels of tanks (e.g. water tank, diesel tank, etc.) into account for the calculation of the center of gravity of the large manipulator, whereby once again an improvement of the determining of the center of gravity results, as the fill levels of the tanks can have considerable influence on the position of the center of gravity of the large manipulator, and thusly influence the supporting forces of the individual supporting legs.

According to a further configuration of the invention, the mobile large manipulator includes sensors to determine the position of the extended support struts, in order to take the support configuration into account as exactly as possible for the determining of the supporting forces.

The supporting aid is advantageously configured to use a numerical simulation, for the establishing of the support forces, e.g. to use a model resting on a physical description of the large manipulator, with which the supporting forces to be set can be simulated. For this purpose, a beam model of the large manipulator can, for example, be used, on the basis of which the supporting forces can be established with an FEM simulation.

An analytic calculation method offers a particular advantage for determining the supporting forces, as the computing power required for this is substantially lower, for example, relative to the above-named numerical simulation.

According to a further advantageous configuration of the invention, the program-controlled supporting aid is configured to control the vertical extension process of the supporting legs and to set the supporting forces for the individual supporting legs according to the determined supporting forces. For this purpose, each supporting leg is assigned a supporting force sensor. The supporting process is substantially simplified for the operator with this measure.

Advantageously, the large manipulator has access to a sensor system for detecting the incline of the chassis, and the supporting aid is configured, at the end of the supporting process, to set the incline of the chassis while preserving the already set supporting forces. Alternatively, the supporting aid can minimize the incline of the chassis, i.e. level the chassis. Through this measure, a manual readjustment of the supports obviates itself, should the chassis not yet be standing levelly after the setting of the support forces, which can lead to an unintended deviation from the optimal supporting forces.

According to a further configuration of the invention, the supporting legs are initially extended by an operator onto the ground, before the supporting aid sets the determined supporting force through the automatic extending of the supporting legs. For one thing, this measure brings about a defined starting point for the automatic support, and the operator can ensure that the supporting legs are lowered correctly onto a sufficiently firm ground before the large manipulator is braced.

The program-controlled supporting aid is configured, according to a further embodiment of the invention, to represent the determined supporting forces on a display unit. The operator of the large manipulator can thusly recognize, even already before the extending of the supporting legs, how the supporting forces should respectively distribute themselves onto the individual supports, and make sure that ground is sufficient for the respective supporting force, in order to provide the structural stability of the large manipulator in the working operation.

In an advantageous configuration of the invention, the supporting legs are extended manually controlled, and the supporting forces measured through the supporting force sensors are set, through the manual vertical retraction or extension of the supporting legs, such that the set supporting forces correspond to the support forces determined through the supporting aid.

Furthermore, the present invention relates to a method for the program-controlled assistance of the supporting process of a mobile large manipulator. The method according to the invention includes the method steps:
determining a support configuration, wherein the support configuration indicates supporting positions of supporting struts of the mobile large manipulator,
determining of the supporting forces for the supporting legs of the mobile large manipulator taking into account the support configuration, in which the chassis of the large manipulator, in the supported state, is set up in an unstressed manner.

Advantageously, the determination of the support forces precedes a determining of the center of gravity of the mobile large manipulator, in order to especially exactly be able to determine the supporting forces, taking into account the center of gravity.

Advantageously, the method according to the invention in addition includes an automatic extension process of the supporting legs, a continuous measurement of the supporting forces, a comparison of the continuously measured supporting forces with the supporting forces to be set, and readjusting of the supporting legs until the measured supporting forces match with the determined supporting forces.

In addition, the method according to the invention is characterized by an automatic levelling of the mobile large manipulator, which in particular, at the conclusion of the supporting process, permits to orient the large manipulator levelly.

Further features, details and advantages of the invention result based on the subsequent description, as well as based on the illustrations. Exemplary embodiments of the invention are represented purely schematically in the following illustrations and are subsequently described in detail in the following. Mutually corresponding subjects or elements are provided with the same reference characters in all figures. They show in:

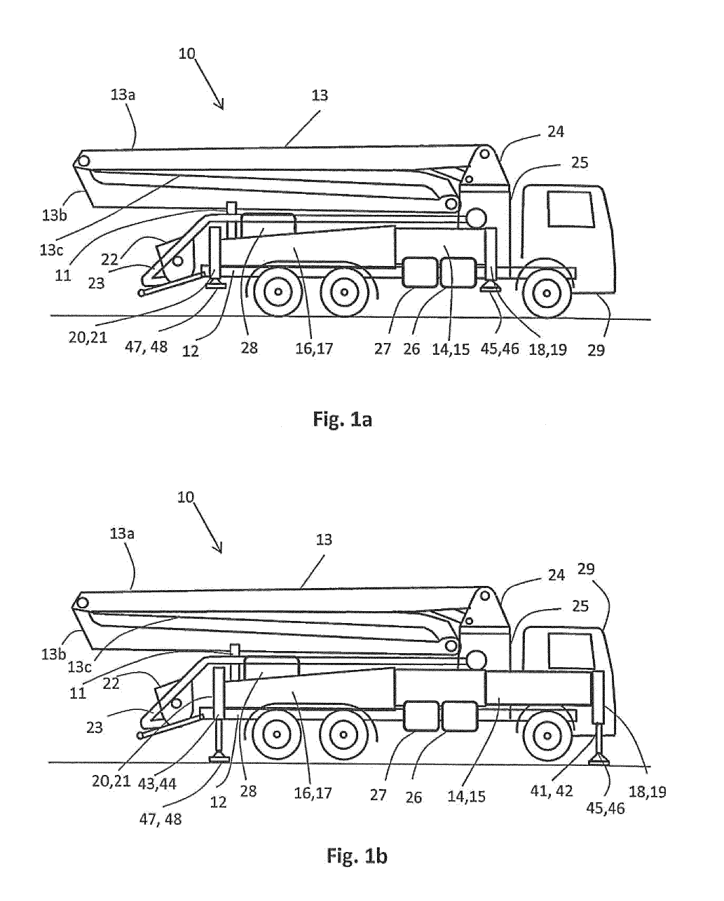

FIG. 1a: a lateral view of a mobile large manipulator according to the invention in travel position

FIG. 1b: a lateral view of a large manipulator according to the invention in a supported position,

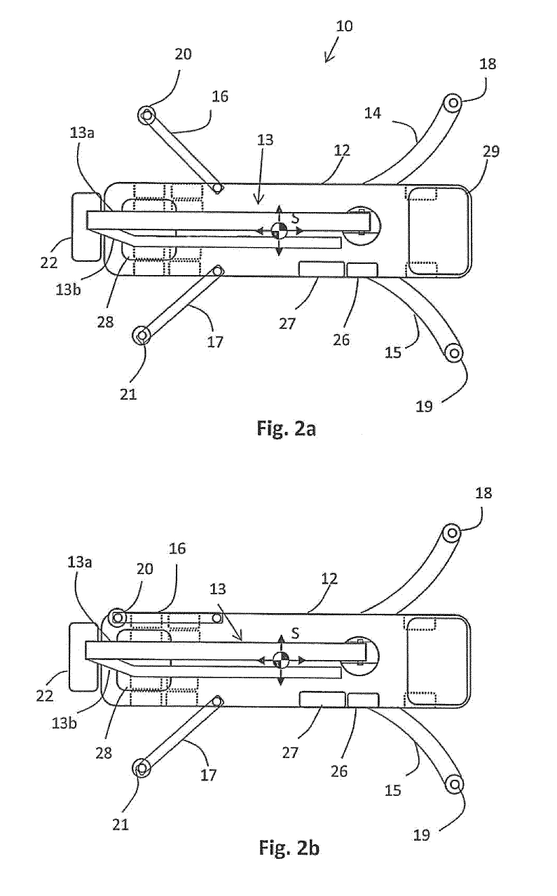

FIG. 2a: a plan view onto a large manipulator according to the invention in a first support configuration

FIG. 2b a plan view onto a large manipulator according to the invention in a second support configuration

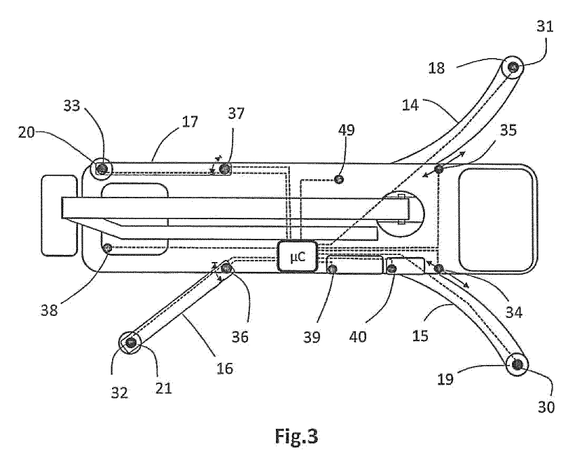

FIG. 3 a plan view onto a large manipulator according to the invention with highlighted electronic components

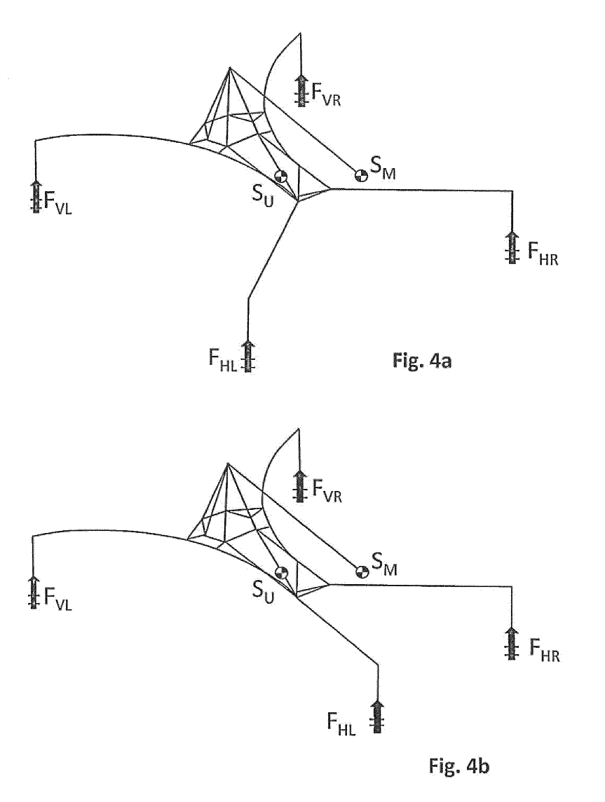

FIG. 4a, 4b: a spatial representation of beam model according to the invention for two different support configurations

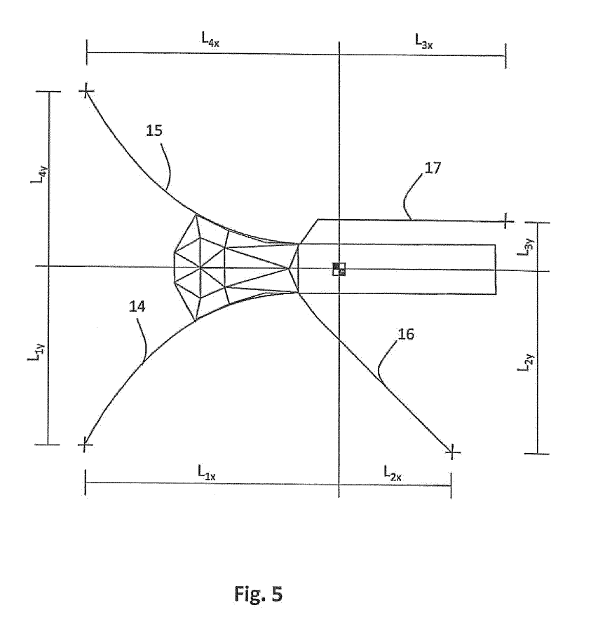

FIG. 5: a plan view onto a beam model of the large manipulator according to the invention

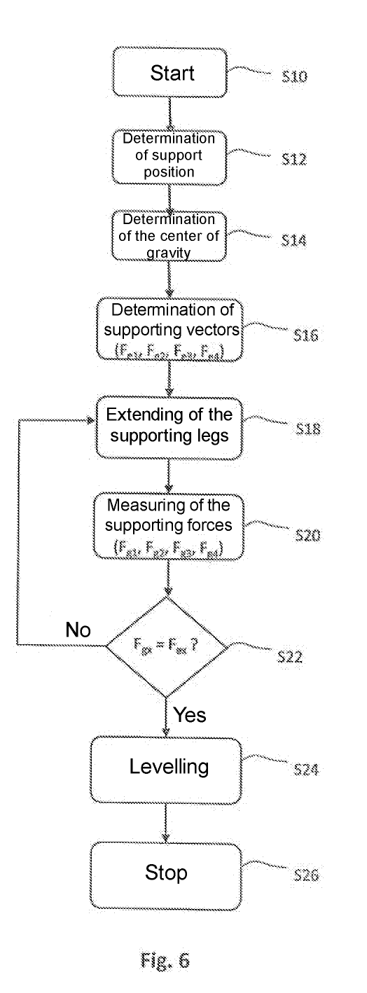

FIG. 6: a flow diagram to illustrate the method according to the invention.

FIG. 1a shows a lateral view of a mobile large manipulator 10 according to the invention in its travel position. The large manipulator 10 comprises a chassis 12 and front 14, 15 and rear 16, 17 horizontally pivotable or telescopable supporting struts, on the ends of which struts vertically extendable supporting legs 18, 19, 20, 21 are arranged. The supporting legs are retractable and extendable by means of drive units 41, 42, 43, 44, for example configured as hydraulic cylinders. While, as represented in the FIG. 2a, 2b, the front supporting struts 14, 15 are configured as horizontally telescopable arc supports, the rear support struts 16, 17 are configured as horizontally pivotably folding supports. Alternatively, in particular the front supporting struts 14, 15 can also be configured as pivotable folding supports or straightly telescopable supporting struts (so-called X supports), but other forms of supporting struts are also possible. The supporting struts 14, 15, 16, 17 are entirely or partially telescopable, pivotable, or extendable in other form from a travel position into a supporting position. Moreover, the mobile large manipulator 10 comprises a working boom 13, pivotable around a vertical axis, with a plurality of mast segments 13a, 13b, 13c jointedly connected with one another, which is rotatably connected with the chassis 12 via a turntable 24 and a rotary tower 25 firmly arranged on the chassis 12. The mobile large manipulator 10, configured in this example as an a truck-mounted concrete pump, further includes a concrete feed hopper 22, a concrete conveying pipe 23, as well as a concrete pump, not represented, arranged on the chassis 12, beneath the mast 13, which pumps the concrete, filled into the feed hopper 22, into the concrete conveying pipe 23, whereby the concrete is then pumped, along the unfolded working boom 13, to a deposition location. The large manipulator 10 further includes different tanks, with different fill levels, for example a diesel tank 26, and additional tank (e.g. ad-blue tank) 27 and a water tank 28, which tank contains water, e.g. for the cleaning of the truck-mounted concrete pump at the end of a work assignment.

FIG. 1b shows a lateral view of the large manipulator 10 in a supported position, i.e. the supporting feet 45, 46, 47, 48 are lowered onto the ground indicated as a horizontal line, and the wheels of the large manipulator 10 are lifted-off of the ground. The working boom 13 is located in the drive position, i.e. it rests on the mast support 11, and the mast segments 13a, 13b, and 13c are folded together.

The FIGS. 2a and 2b respectively show a plan view onto the large manipulator 10 according to the invention with different support configurations.

In FIG. 2a, the mobile large manipulator is represented in a first support configuration, the so-called full support, that is, the front 14, 15 and rear 16, 17 supporting struts are horizontally pivoted or extended or telescoped out up to their end position. The support configuration should, as a rule, be selected, because the large manipulator 10 is designed such that in this support configuration, the working boom 13 can be moved freely in all directions without endangering the stability of the large manipulator 10. The supporting forces distribute themselves relatively uniformly onto the front 18, 19 and the rear 20, 21 supporting legs in this deployment.

The term “support configuration” refers, in this context, to the supporting positions of the individual supporting struts 14, 15, 16, 17.

In the support configuration of the large manipulator 10 according to FIG. 2b, the left rear support strut 16 is not pivoted, that is, it remains, for this support configuration, in the travel position. This support configuration, forming a so-called partial support, is selected, for example, if obstacles are present on the construction site in the rear left region of the large manipulator 10, whereby the pivoting of the supporting strut 16 is not possible. In this support configuration, the operator must take into consideration that the working boom 13 may only be moved in a limited manner, in order not to endanger the stability. The limited working region of the working boom 13, in a partial supporting, is usually monitored through a suitable sensor system in modern truck-mounted concrete pumps.

In other forms of a partial supporting, only the left 14, 16, or the rear 16, 17 supporting struts are partially or not at all extended, for example. Other forms of the partial supporting are possible, as well.

FIG. 3 shows a plan view onto the large manipulator 10 supported, in a partial support, with special emphasis on the electrical/electronic components of the program-controlled supporting aid according to the invention.

Supporting force sensors 30, 31, 32, 33 are respectively arranged on the supporting legs 18, 19, 20, 21, which sensors detect the supporting forces Fₑ₁, Fₑ₂, Fₑ₃, Fₑ₄ acting on the supporting feet 45, 46, 47, 48. These types of sensors are based, for example, on the usage of strain gauges (DMS), as described in the patent publication EP1675760. Alternatively, for example, the hydraulic oil pressures can be determined in the drive units 41, 42, 43, 44 of the supporting legs configured as hydraulic cylinders. The measurement of the supporting forces is, as a rule, most reliable if the force is determined directly in or on the supporting foot 45, 46, 47, 48, but the determining of the supporting forces in the upper region of the supporting legs, e.g. on a bolt, to which the hydraulic cylinder is fastened to extend the supporting leg, would also be possible. It is further conceivable to attach a sensor system, e.g. in the form of strain gauges or the like, to the supporting struts 14, 15, 16, 17, in order to determine the supporting forces acting on the supporting legs 18, 19, 20, 21, via the deflection of the supporting struts 14, 15, 16, 17.

Position sensors 34, 35, 36, 37 respectively are arranged, in the region of the supporting struts 14, 15, 16, 17, on the chassis 12, to detect the extension state of the supporting struts 14, 15, 16, 17. In the two front supporting struts 14, 15, which in this example are embodied as curved-shaped, cable-pull sensors, for example, can be used as sensor 34, 35 for the longitudinal measurement. If only discrete extended positions are permitted (e.g. supporting struts not/halfway/fully extended), simple mechanical, magnetic or the like switching sensors are also sufficient, by means of which it is determined if the supporting struts 14, 15, in the extending, have reached one of the permitted positions. In the rear, foldably-designed supporting struts 16, 17, pivot angle sensors 36, 37, for example, can be employed on the joints, or distance measuring systems on the (not represented) hydraulic cylinders, which pivot the supporting struts 16, 17. Likewise, radio position determining methods, as are known, for example, from the document DE 102008055625 A1, would be employable. In the simplest case, switching sensors could be used to detect the position for the states “supporting strut completely folded down” or “supporting strut not folded down”.

The position sensors 34, 35, 36, 37 are connected with a program-controlled supporting aid μC via signal lines. Based on the output signals of the position sensors 34, 35, 36, 37 on the supporting struts 14, 15, 16, 17, the program-controlled supporting aid μC determines the selected supporting position of the large manipulator 10, even before or also while the supporting feet 45, 46, 47, 48 are being lowered onto the ground. The working boom 13 is still located in its travel position at this point in time. The extension state of the supporting struts 14, 15, 16, 17 does not necessarily need to be detected via a sensor system. It is, for example, possible that the operator of the large manipulator 10 selects a desired working region for the boom 13 before the actuation of the supporting struts 14, 15, 16, 17, and the control specifies the supporting positions necessary for this working region, which the operator then sets through the extending of the supporting struts 14, 15, 16, 17, without the support configuration, i.e. the supporting position of the supporting legs, being ultimately sensorially detected. The supporting aid μC can then determine the supporting forces to be set based on the pre-specified support configuration, as well.

The program-controlled supporting aid μC is furthermore, for example directly via signal lines, connected with a fill level sensor 40 for the diesel tank 28, a fill level sensor 39 for the ad-blue tank 27 and a fill level sensor 38 for the water tank 28. The data about the fill levels, in particular of the diesel tank 26 and the ad blue tank 27 can, for example, also be retrieved, via a suitable data bus connection, from the control electronics of the travel drive of the large manipulator 10. The fill levels of the tanks 26. 27, 28 can alternatively also be input by the operator of the large manipulator 10 via a suitable input unit, connected with the program-controlled supporting aid μC. From the fill levels of the tanks 26, 27, 28, the program-controlled supporting aid μC derives the respective weight of the tanks 26, 27, 28.

Further, the operator can, for example, input, via the operating unit, information (in particular position and weight) about a loading of the large manipulator 10, for example concrete conveying pipes mounted on the chassis 12. Further, the supporting aid μC is connected with an incline sensor 49 arranged on the chassis 12, which sensor detects the incline of the large manipulator.

On the basis of the support configuration of the large manipulator 10 with the working boom in the travel position 13 and, if necessary taking into account the weight and the position of the tanks 26, 27, 28 and further payload, the program-controlled supporting aid μC determines the center of gravity S of the large manipulator 10 and the supporting forces Fₑ₁, Fₑ₂, Fₑ₃, Fₑ₄ to be set, separately for each supporting leg 18, 19, 20, 21, in which the chassis 12 is supported as tensionlessly as possible. During, and in particular at the end of the supporting process, i.e. in the vertical extending of the supporting legs 18, 19, 20, 21, it must be ensured that the supporting forces Fₑ₁, Fₑ₂, Fₑ₃, Fₑ₄ to be set, at the conclusion of the supporting process, match with the measured supporting forces F_{g1}, F_{g2}, F_{g3}, F_{g4} a as exactly as possible. This can, for example, occur manually, in that the supporting forces Fₑ₁, Fₑ₂, Fₑ₃, Fₑ₄ to be set are represented on a display unit, and the operator sets the supporting forces F_{g1}, F_{g2}, F_{g3}, F_{g4}, measured with the supporting force sensors 30, 31, 32, 33, of the supporting legs 18, 19, 20, 21 lowered onto the ground, which forces are likewise represented on the display unit, through targeted retracting/extending of the individual supporting legs 18, 19, 20, 21, such that the required supporting forces Fₑ₁, Fₑ₂, Fₑ₃, Fₑ₄ are set at the supporting feet 45, 46, 47, 48. Alternatively, the program-controlled supporting aid μC actuates the drive units 41, 42, 43, 33 of the supporting legs 18, 19, 20, 21, continuously detects the supporting forces F_{g1}, F_{g2}, F_{g3}, F_{g4} measured by the supporting force sensors 30, 31, 32, 33, and compares these forces with the supporting forces Fₑ₁, Fₑ₂, Fₑ₃, Fₑ₄ to be set until the measured supporting force values match with the determined supporting force values.

In case the center of gravity S of the large manipulator is not to be taken as constant, the program-controlled supporting aid μC must initially determine the center of gravity S of the large manipulator. On the basis of this center of gravity S, the supporting forces Fₑ₁, Fₑ₂, Fₑ₃, Fₑ₄ to be set are, taking into account the extended position of the supporting struts 14, 15, 16, 17, determined for the individual supporting legs 18, 19, 20, 21, which legs, in the supporting with a still folded-in working boom 13, are necessary, so that the chassis 12 is not tensioned at the end of the deployment process.

The center of gravity S of the large manipulator 10 is, for example, only then to be taken as constant, if the extension state of the supporting struts 14, 15, 16, 17, with the supporting legs 18, 20, 21, 22, has a negligibly small influence on the position of the center of gravity S of the large manipulator 10. If this is not the case, the extension state of the supporting struts 14, 15, 16, 17 and the positions of the centers of gravity of the supporting struts 14, 15, 16, 17 dependent thereupon, including the supporting legs 18, 20, 21, 22, must be taken into account in the calculation of the center of gravity S of the large manipulator 10 through the program-controlled supporting aid μC.

The total weight of the large manipulator 10 is not necessarily required in the determination of the supporting forces Fₑ₁, Fₑ₂, Fₑ₃, Fₑ₄ to be set, as the supporting forces can also be determined as relative values. The actual total weight and the absolute supporting forces Fₑ₁, Fₑ₂, Fₑ₃, Fₑ₄ to be set for each supporting leg 18, 19, 20, 21 can also only be determined when lifting the large manipulator. For this purpose, the total weight of the large manipulator 10 is initially determined through the addition of the measured supporting forces F_{g1}, F_{g2}, F_{g3}, F_{g4} and, based on the determined total weight and the determined relative supporting forces, the absolute supporting forces Fₑ₁, Fₑ₂, Fₑ₃, Fₑ₄ are then derived and are ultimately set in the supporting process.

Through the unstressed set-up of the chassis 12, the supporting forces are optimally distributed onto the supporting legs 18, 19, 20, 21 in an unfolded working boom 13 as well, so that overly high stressings of the individual supporting legs 18, 19, 20, 21 also do not arise in the working operation with extended working boom 13.

The supporting forces for the individual supporting legs can, for example, be determined with the aid of methods of numerical simulation, such as the Finite Element Method (FEM) and the multi-body simulation (MKS), or with the aid of suitable analytical calculation methods.

In the FIGS. 4a and 4b, an FE simulation model, respectively, with different support configurations of the large manipulator 10, is exemplarily represented to determine the supporting forces Fₑ₁, Fₑ₂, Fₑ₃, Fₑ₄ for the individual supporting legs. The FE model represented in FIGS. 4a and 4b substantially consists of beam elements without mass of finite rigidity for illustrating the bearing structure of the large manipulator and consists of two mass elements to take into account the own weight of the large manipulator (subsequently named FE beam model). The total own weight of the large manipulator here is divided into two parts: a mass element with position SM takes into account the own weight of the boom, a second mass element with position Su illustrates the own weight of the substructure.

Alternatively, to the beam elements, the rigidity of the bearing structure of the large manipulator, in a FE model, can also be illustrated with spring elements. The total own weight of the large manipulator can be taken into account with a single, or also with more than two mass elements.

FIG. 5 shows a plan view onto the FE beam model from FIGS. 4a, 4b. The beam model here serves, however, merely to represent the extension positions of the supporting struts 14, 15, 16, 17 and to illustrate a suitable analytic calculation method for determining Fₑ₁, Fₑ₂, Fₑ₃, Fₑ₄.

The analytical calculation process rests upon the statistical equations for the moment and force equilibrium of the large manipulator 10. This can be generally represented as a linear equation system of the form

$$\underbrace{[ \begin{matrix}0 \\ 0 \\ {F}_{g}\end{matrix} ]}_{T} = \underbrace{[ \begin{matrix}{L}_{1 x} & {L}_{2 x} & {L}_{3 x} & {L}_{4 x} \\ {L}_{1 y} & {L}_{2 y} & {L}_{3 y} & {L}_{4 y} \\ 1 & 1 & 1 & 1\end{matrix} ]}_{A} \underbrace{[ \begin{matrix}{F}_{e 1} \\ {F}_{e 2} \\ {F}_{e 3} \\ {F}_{e 4}\end{matrix} ]}_{{F}_{e}} \qquad ( 1 )$$

Here, the expressions Lᵢₓ, for i=1, . . . , 4, reference the distances of the supporting feet to the overall center of gravity S of the large manipulator 10 in the longitudinal axis of the large manipulator 10, and the expressions L_{iy}, for i=1, . . . , 4, reference the distances of the supporting feet to the overall center of gravity S of the large manipulator 10 in the direction orthogonal to the longitudinal axis of the large manipulator 10. The weight force of the entire large manipulator is referenced with F_{g}. The equation system (11) is moreover representable as a linear matrix equation with the vectors T or Fₑ and the matrix A.

The equation system (11) represents, with three equations for four unknowns (the supporting forces Fₑ₁, Fₑ₂, Fₑ₃, Fₑ₄), an under-determined equation system and, in general, has an infinite number of solutions. To determine the solution, which represents the unstressed state of the large manipulator, the knowledge that, in the unstressed state, the sum of the squares of the support is minimal, is now used. The task formulation is thusly described as a minimization problem of the form

$${min}_{{F}_{e 1} , {F}_{e 2} , {F}_{e 3} , {F}_{e 4}} = {F}_{e 1}^{2} + {F}_{e 2}^{2} + {F}_{e 3}^{2} + {F}_{e 4}^{2} , \qquad ( 2 )$$

wherein the equation system (11) must be fulfilled as an auxiliary condition. The analytic solution of this minimization problem specified is through

Fₑ=A^{†}T (3)

with the pseudoinverse of the matrix A,

A^{†}=A^{T}(AA^{T})⁻¹ (4)

With the abovementioned calculation method, the following supporting forces Fₑ₁, Fₑ₂, Fₑ₃, Fₑ₄ to be set are determined in the following, for example for a supporting of the large manipulator 10 according to FIG. 5 (i.e. the supporting struts 14 (front left); 15 (front right); and 16 (rear left) are fully extended, and the support strut 17 (rear right) is not extended):

| | Fₑᵢ | Fₑᵢ |
|---|---|---|
| | Absolute | Relative |
| Front Left | 35 | 10% |
| Front Right | 90 | 26% |
| Rear Right | 130 | 38% |
| Rear Left | 91 | 26% |

It is clearly recognizable that a much higher supporting force is to be set on the not folded-down supporting strut 17 (rear right) than on the other support struts 14, 15 and 16. The diagonally opposite support strut 14 (front left) must, by contrast, be less loaded, in order to set-up the large manipulator 10 in an untenionsed manner.

The target supporting forces Fₑ₁, Fₑ₂, Fₑ₃, Fₑ₄ do not necessarily have to be calculated anew before every deployment of the machine. It is also possible to permit only defined supporting positions of the support struts, in which, for example, the individual supporting struts 14, 15, 16, 17 are only allowed to be extended horizontally up to 100%, 50% and 0%. A manageable number of possible supporting positions of the supporting struts 14, 15, 16, 17 results therefrom, for which respectively previously determined target supporting forces Fₑ₁, Fₑ₂, Fₑ₃, e.g. in table form, are stored in a store. The program-controlled supporting aid μC then picks practically only the target supporting forces Fₑ₁, Fₑ₂, Fₑ₃, Fₑ₄ necessary for pre-specified and set supporting position out of the table, in which supporting forces the chassis 12 of the large manipulator 10 is set-up unstressed, in the supported state. Here, the center of gravity of the machine can be assumed to be constant or unchanging, or the program-controlled supporting aid μC determines the respectively current center of gravity and corrects the values from the table, which e.g. apply for a middle center of gravity, corresponding to the determined center of gravity. FIG. 6 shows a flow diagram according to the invention with the method steps, which processes the supporting aid μC until the large manipulator 10, in the sense of the invention, is set-up tension-free and leveled.

In step S10, the process starts. In step S12, the support configuration of the large manipulator 10 is determined, for example by querying the position sensors 34, 35, 36, 37 of the supporting struts 14, 15, 16, 17. Taking into consideration the fill levels (weights) of the tanks 26, 27, 28 and the payload, the supporting aid μC determines, in step S14, the center of gravity S of the large manipulator 10. In step S16, the supporting aid μC determines, for example with the aid of an iterative approximation method, an analytic calculation method or through reading from a table, as set out above, the supporting forces Fₑ₁, Fₑ₂, Fₑ₃, Fₑ₄ to be set for the individual supporting legs 18, 19, 20, 21, which lead to an unstressed set-up of the large manipulator 10. In the calculation, it is assumed that the working boom 13 lies folded together in the mast support 11, i.e. is in the travel position. In step S18, the supporting aid μC controls the extension process of the supporting legs 18, 19, 20, 21, with the aid of the drive units 41, 42, 43, 44, and, in step S20, constantly queries the currently measured supporting forces F_{g1}, F_{g2}, F_{g3}, F_{g4} from the supporting force sensors 30, 31, 32, 33. In step S22, the supporting aid μC, through targeted extending and retracting of the supporting legs 18, 19, 20, 21, actuates the drive units of the supporting legs until the actually measured supporting force values F_{g1}, F_{g2}, F_{g3}, F_{g4} correspond to the supporting force values Fₑ₁, Fₑ₂, Fₑ₃, Fₑ₄ to be set, that is F_{g1}=Fₑ₁, F_{g2}=Fₑ₂, F_{g3}=Fₑ₃, F_{g4}=Fₑ₄.

As soon as the supporting forces in step S22 are optimally set, another leveling of the large manipulator 10 occurs in step S24, i.e. the supporting legs are, for example, displaced in pairs (i.e. always two left/right or front/rear struts), until the large manipulator 10 is horizontally oriented.

The flow diagram contains all required method steps in order to set-up the large manipulator 10 fully automatically. As already set out further above, some of these method steps are optional or can also be carried out manually by the operator of the large manipulator 10.

The leveling of the large manipulator can also be an integral part of the supporting force setting, i.e. the levelling is not temporally connected to the supporting force setting, but the large manipulator 10 is rather also automatically leveled in the course of the supporting force setting.

Alternatively, the setting of the supporting forces F_{g1}, F_{g2}, F_{g3}, F_{g4} would also be possible via distance measuring sensors on the supporting legs 18, 19, 20, 21. This presupposes that, for example, the rigidities of the supporting struts 14, 15, 16, 17 are known, and an initially defined state was produced before the configuring of the large manipulator 10. Under these preconditions, the supporting forces F_{g1}, F_{g2}, F_{g3}, F_{g4} acting upon the supporting legs 18, 19, 20, 21 can be derived and, as represented further above, can be set corresponding to the determined supporting forces Fₑ₁, Fₑ₂, Fₑ₃, Fₑ₄, via suitable distance measuring sensors, which determine the extension length of the supporting legs 18, 19, 20, 21.

As soon as the deployment process is completed, the large manipulator 10 can be put into service, i.e. the mast 13, for example in a truck-mounted concrete pump, can be lifted out of the mast support 11 and be unfolded, in order to carry out the concreting operation.

The determination of the supporting forces was disclosed here by the example of a truck-mounted concrete pump. The invention is applicable to other forms of large manipulators, e.g. in the form of truck-mounted cranes, elevating work platforms, fire engine turnable ladders, among others, however. The invention can, in addition, also find application in large manipulators which, for the working operation, are supported on the ground with more than four supporting legs.

### LIST OF REFERENCE CHARACTERS

10 mobile large manipulator
11 mast support
12 chassis
13 working boom
13a-c working boom segments
14-17 supporting struts
18-21 supporting legs
22 feed hopper
23 concrete conveying pipe
24 turntable
25 rotary tower
26 diesel tank
27 ad blue tank
28 water tank
29 driver's cab
30-33 supporting force sensors
34-37 position sensors supporting struts
38-40 tank fill level sensors
41-44 drive units
45-48 supporting feet
49 incline sensor

1-16. (canceled)

17. A mobile large manipulator comprising:
a chassis;
an unfoldable and/or extendable working boom arranged rotatably around a vertical axis on the chassis;
supporting struts respectively arranged on the chassis and are horizontally extendable from a travel position to a supporting position;
vertically extendable supporting legs arranged on respective outer ends of the supporting struts, the supporting legs support the mobile large manipulator via respective supporting forces of the supporting legs;
a micro-controller-based program-controlled supporting aid configured to determine supporting forces for the respective supporting legs based, at least in part, on the supporting position of the supporting struts in which the chassis of the large manipulator is deployed unstressed in a support state.

18. The mobile large manipulator according to claim 17, wherein the supporting aid is further configured to determine the supporting forces based, at least in part, on a center of gravity of the large manipulator.

19. The mobile large manipulator according to claim 18, wherein the supporting aid is configured to calculate a position of the center of gravity of the large manipulator.

20. The mobile large manipulator according to claim 19, wherein the supporting aid is configured to calculate the position of the center of gravity based, at least in part, on fill levels of tanks of the large manipulator.

21. The mobile large manipulator according to claim 17, further comprising:
sensors configured to determine the supporting position of the supporting legs.

22. The mobile large manipulator according to claim 17, wherein the support aid is configured to determine the supporting forces via a numerical simulation.

23. The mobile large manipulator according to claim 17, wherein the supporting aid is configured to determine the supporting forces via an analytical calculation process.

24. The mobile large manipulator according to claim 17, wherein each supporting leg is assigned a supporting force sensor for measurement of the respective supporting force, and the supporting aid is configured to control extension of the supporting legs such that the measured supporting forces are set for the respective supporting legs in accordance with the determined supporting forces.

25. The mobile large manipulator according to claim 24, wherein the large manipulator includes a sensor system to determine an incline of the chassis, wherein the supporting aid is configured to minimally set the incline of the chassis while maintaining the already set supporting forces or while simultaneously setting the supporting forces.

26. The mobile large manipulator according to claim 24, wherein the supporting legs are extendable to the ground by an operator before the program-controlled supporting aid sets the determined supporting forces.

27. The mobile large manipulator according to claim 17, wherein the supporting aid is configured to represent the determined supporting forces on a display unit.

28. The mobile large manipulator according to claim 27, wherein, through manual extension of the supporting legs, the supporting forces measured through sensors are set such that such forces correspond to the supporting forces determined through the supporting aid.

29. A method for program-controlled assistance of a supporting process of a mobile large manipulator with a chassis, an unfoldable and/or extendable working boom arranged rotatably around a vertical axis on the chassis, supporting struts respectively arranged on the chassis and horizontally extendable from a travel position to a supporting position, and vertically extendable supporting legs arranged on respective outer ends of the supporting struts and that support the mobile large manipulator via respective supporting force of the supporting legs, the method comprising:
determining a support configuration indicating supporting positions of the supporting struts of the large manipulator; and
determining supporting forces for the respective supporting legs of the large manipulator while taking into account a support configuration, in which the chassis of the large manipulator, in the supported state, is deployed unstressed.

30. The method according to claim 29, further comprising:
determining a center of gravity of the mobile large manipulator, which is taken into account for the determining the supporting forces.

31. The method according to claim 30, further comprising:
extending the supporting legs;
continuously measuring the supporting forces while extending the supporting legs;
comparing the continuously measured supporting forces with the supporting forces to be set; and
readjusting the supporting legs until the measured supporting forces match the determined supporting forces.

32. The method according to claim 29, further comprising:
automatic leveling of the mobile large manipulator.
